(19) United States
(12) Patent Application Publication
(10) Pub. No.: US 2006/0068756 A1
(43) Pub. Date: Mar. 30, 2006

(54) Mobile user authentication in connection with access to mobile services

(76) Inventors: Stefan Aberg, Helsinki (FI); Timo Pakkala, Espoo (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/539,787

(22) PCT Filed: Dec. 18, 2002
(86) PCT No.: PCT/IB02/05461

§ 371 Date: Jun. 17, 2005

(51) Int. Cl. H04M 1/66

(52) U.S. Cl. 455/411; 455/466

(57) ABSTRACT

The present invention relates to a method and a system for enabling a server (120) on a packet switched network (130) to authenticate a user of a wireless terminal (100) prior to granting the terminal access to a service administrated by the server. According to the invention, the wireless terminal (100) initiates transmission of a first set of user identification parameters to a server (120) over a first communication path (140), after which the terminal (100) transmits a second set of user identification parameters to the server (120) over a second communication path (150). The server (120) then bases authentication of the wireless terminal (100) on a match between the first set of parameters and the second set of parameters.

### TECHNICAL FIELD OF THE INVENTION

The present invention relates to a method and a system for enabling a server on a packet switched network to authenticate a user of a wireless terminal prior to granting the terminal access to a service.

### TECHNICAL BACKGROUND AND PRIOR ART

At present, there is an increasing interest to be able to use mobile devices, or wireless terminals, as access devices for web browsing, intranet access, access to personal electronic mailbox accounts, as well as to other services supporting such mobile access. Lately, many services supporting such access by wireless terminals have been implemented so as to base its communication on the Wireless Application Protocol (WAP), so called WAP services.

Before granting a wireless terminal access to a service it is most often desired, not to say required in case the service is a corporate intranet or a personal electronic mailbox account, to perform some kind of authentication of the wireless terminal or wireless terminal user. A problem in connection with this is that the server hosting the service need some user specific, or terminal specific, information on which the authentication can be based. This is particularly a problem in connection with WAP (Wireless Application Protocol) services in those cases the MISISDN (Mobile Station Integrated Services Digital Network) number of the wireless terminal is not transferred to the server hosting the WAP service during access of the service.

In U.S. Pat. No. 6,078,908, a method for authorization in data transmission systems is described. A user sends a qualifying identification of a data input apparatus together with a request for the generation, or selection, of a transaction authorization number (TAN) to an authorization computer. The authorization computer answers by sending a TAN over a second communication path, different from the first communication path, to a monitor, e.g. a pager. The user reads the TAN on the monitor and enters it to the data input apparatus. The TAN is transmitted to the authorization computer which validates it in order to establish a connection between the data input apparatus and a receiver unit.

This solution according to U.S. Pat. No. 6,078,908 not only requires the implementation of an authorization computer, but it is a cumbersome and not a very convenient way for the user of the data input apparatus to authenticate himself. Further it needs two terminals used for authentication.

### SUMMARY OF THE INVENTION

The present invention provides a method and a system for enabling a server to authenticate a connecting wireless terminal user when no unique terminal identification is received by the server during establishment of a session with a calling wireless terminal.

According to the present invention, a method according to independent claim 1 and a system according to independent claim 13 are provided. Preferred embodiments are defined in the dependent claims.

According to the invention, a wireless terminal initiates transmission of a first set of user identification parameters to a server over a first communication path, after which the terminal transmits a second set of user identification parameters to the server over a second communication path. The server then bases authentication of the wireless terminal on a match between the first set of parameters and the second set of parameters.

Thus, after reception of the second set of parameters over the second communication path, and authentication of the terminal by matching the two sets of parameters, the server can grant the terminal access to a service, for which authentication is required, over the second communication path. This is accomplished even though access to the server is performed by means of a communication session during which establishment there are no unique terminal identification data transferred to the server.

Further features and advantages of the invention will become more readily apparent from the following detailed description of a number of exemplifying embodiments of the invention. As is understood, various modifications, alterations and different combinations of features coming within the spirit and scope of the invention will become apparent to those skilled in the art when studying the general teaching set forth herein, and the following detailed description.

### BRIEF DESCRIPTION OF THE DRAWINGS

Exemplifying embodiments of the present invention will now be described with reference to the accompanying drawings, in which:

FIG. 1 schematically shows an exemplifying system and its operation in accordance with an embodiment of the invention;

FIG. 2 schematically shows an exemplifying system and its operation in accordance with another embodiment of the invention;

FIG. 3 shows a flow chart with the basic operation of the embodiment in FIG. 2; and

FIG. 4 schematically shows an exemplifying system and its operation in accordance with yet another embodiment of the invention.

### DETAILED DESCRIPTION OF THE INVENTION

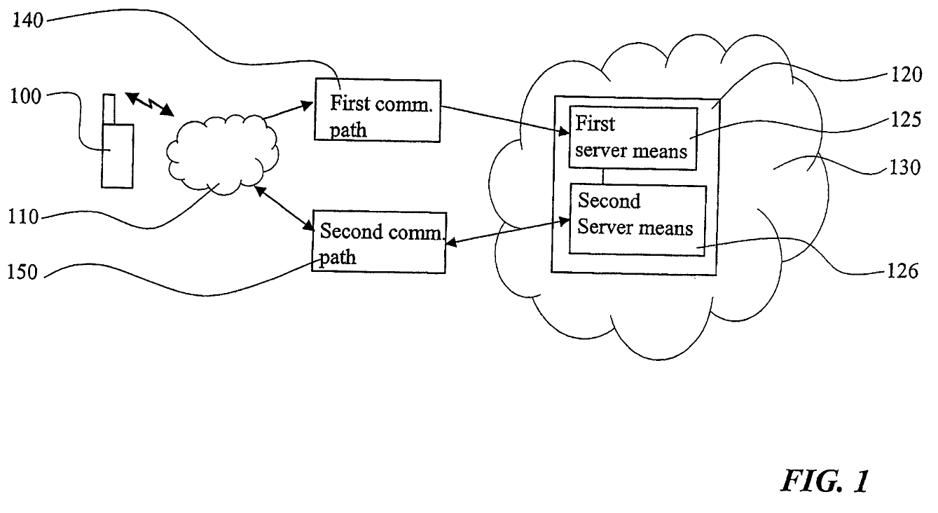

With reference to FIG. 1 an exemplifying embodiment of the invention will now be described. FIG. 1 shows a wireless terminal 100 connected to a radio communications network 110 and a server 120 of a packet switched network 130. FIG. 1 also illustrates the existence of a first communication path 140 and of a second communication path 150.

The server 120 administrates a service to which access is desired by the wireless terminal. This service is either implemented and executed on the server 120 itself or any another server (not shown) with which the server 120 communicates over the packet switched network 130. The packet switched network 130 can be the Internet, a corporate intranet or any other packet switched network. The server 120 includes first server means 125 for communication over the fist communication path 140, second server means for communication over the second communication path 150, as well as means for authenticating a connecting wireless terminal.

Furthermore, the server 120 may support content conversion between protocols used by the wireless terminal and any other server on the packet switched network.

The wireless terminal 100 is adapted to communicate with the server 120 over the first communication path 140 as well as over the second communication path 150.

An exemplifying mode of operation of the embodiment in FIG. 1 is as follows. When the user of the wireless terminal 100 wishes to access a service administrated by the server 120, he first initiated the transmission of a first set of user identification parameters over the first communication path 140 to the first server means 125. The user then accesses the second server means 126 over the second communication path and transmits a second set of user identification parameters to the server. If the server 120 authenticates the terminal successfully based on a comparison of the two received sets of user identification parameters, the wireless terminal 100 will be granted access to the service administrated by the server 120.

This way of accessing the service, while at the same time being authenticated, is very intuitive to the user. With a simple command to the terminal, the user may initiate transmission of the first set of parameters to the server. Subsequently, a URL (Uniform Resource Locator) stored as a bookmark can be used for establishing the session over the second communication path with the server. The user then completes the second set of parameters for transmission to the server, after which the server authenticates the user and grants access to the requested service over the established session.

Obviously, there are various way of completing the second set of parameters. For example, according to an embodiment, the first and the second set of parameters will include a password. This password may advantageously be the same as the PIN code normally used by the user together with the terminal. Thus, the step of completing the transmission of the second set of parameters may advantageously be implemented by a step of simply requiring the user to enter this PIN code.

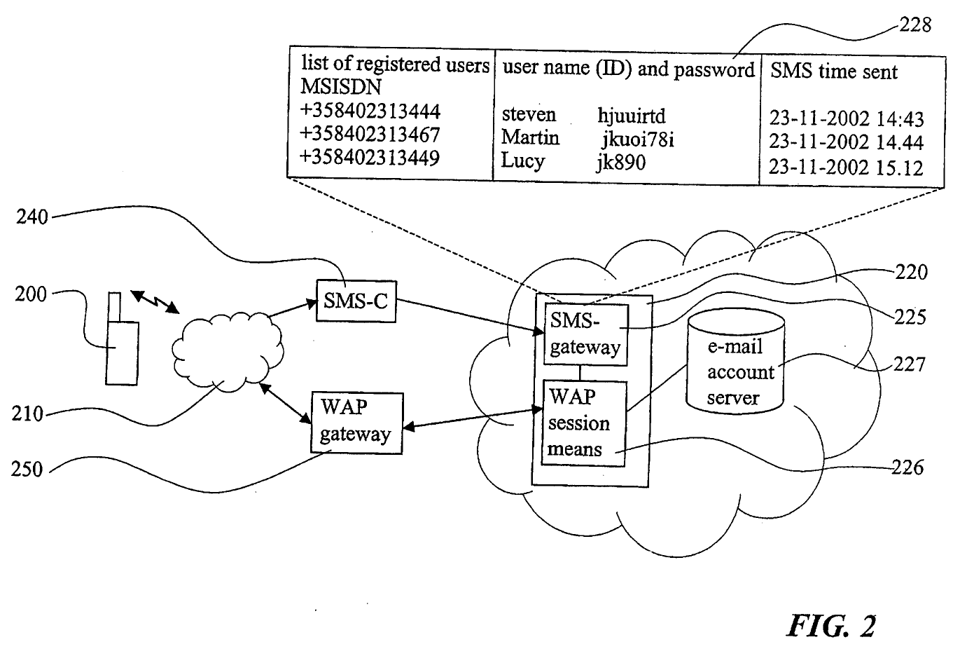

With reference to FIG. 2 another exemplifying embodiment of the invention will now be described. In this embodiment the wireless terminal 200 is equipped with WAP protocol stack and a browser supporting WML (Wireless Markup Language) for browsing the Internet, an intranet, or the like, i.e. the wireless terminal is able to operate as a WML client. However, it should be understood that the wireless terminal could be any device that is adapted to interface to the Internet or an intranet and communicate with servers on such a network using any of the presently known markup languages, either directly or through some protocol gateway. The wireless terminal 200 is connected to a radio communications network 210 and supports utilization of a short message service provided by that network.

The first communication path for transmitting the first set of parameters to the server 220 is a communication path provided via an SMS-C (Short Message Service Centre) 240. The second communication path for transmitting the second set of parameters to the server 220 is a communication path provided by a WAP (Wireless Application Protocol) session between the wireless terminal 200 and the server 220 via a WAP gateway 250. By means of the first communication path, the wireless terminal is able to initiate a transmission of an SMS message to the server 220 administrating the service to which access is desired. By means of the second communication path, the wireless terminal is able to initiate a WAP session over the WAP gateway 250 with the server 220 administrating the service.

The wireless terminal initiates the transmission of the first set of parameters by requesting the SMS-C to, transmit an SMS message to the server, in which server the SMS message is received by an SMS gateway. The SMS gateway then derives the first set of parameters based on the MSISDN of the terminal that initiated the SMS message, which MSISDN will be included in the originating address field of the received SMS message. The parameters, such as a user identification parameter in the form of a user name, or, alternatively the MSISDN number, and an associated password, will be forwarded from the SMS gateway to the service administrated by the server in order for the service to later base authentication of the terminal user on these parameters.

The wireless terminal transmits the second set of parameters, which second set includes the same parameters as the first set, over an established WAP session via the WAP gateway. As is understood, depending on the technology used, this session could alternatively be established via a combined WAP gateway/server within the server administrating the service.

As stated, the server 220 administrates a service to which access is desired by the wireless terminal 200. The server 220 includes an SMS gateway 225 for communicating with the wireless terminal over the SMS-C 240, WAP session means 226 for communicating with the wireless terminal over a WAP session, as well as means for authenticating a connecting wireless terminal. The SMS gateway 225 is operative to transfer information, derived from and/or received in, an SMS message to the WAP session means 226. The WAP session means 226 has a design and operation corresponding to that of a WAP server and is thus capable of performing services on behalf of a connecting wireless terminal. It may thus also be capable of performing content conversions, for example from/to WML to/from HTML (HyperText Markup Language) or any other markup language which may be used by any other server on the Internet or intranet with which the WAP session means is to communicate in order to administrate the desired service. Such conversion also includes converting to/from the information format used by any database which is needed to be accessed for administrating the desired service.

Thus, this embodiment comprising a WAP session for the second communication path will be advantageous in a situation where the wireless terminal's MSISDN number is not received by the server when a WAP session is established between the two. In such a situation, the server administrating a service for which authentication is needed, will have no user or terminal information on which to base the authentication. However, by transferring such user or terminal information over the first communication path beforehand, the server can authenticate the terminal by matching the previously received user or terminal information with that user or terminal information which is transferred by the user to the server over the WAP session.

Additional security is added by requiring that the second set of parameters is transmitted over the second communication path within a predefined time limit, such as e.g. two minutes, following the point in time when the first set of parameters were transmitted to the server.

In this embodiment referred to by FIG. 2, the exemplifying service is an electronic mailbox account service administrated by the server 220. Thus, the WAP session means 226 communicates with a second server implementing an e-mail account server 227.

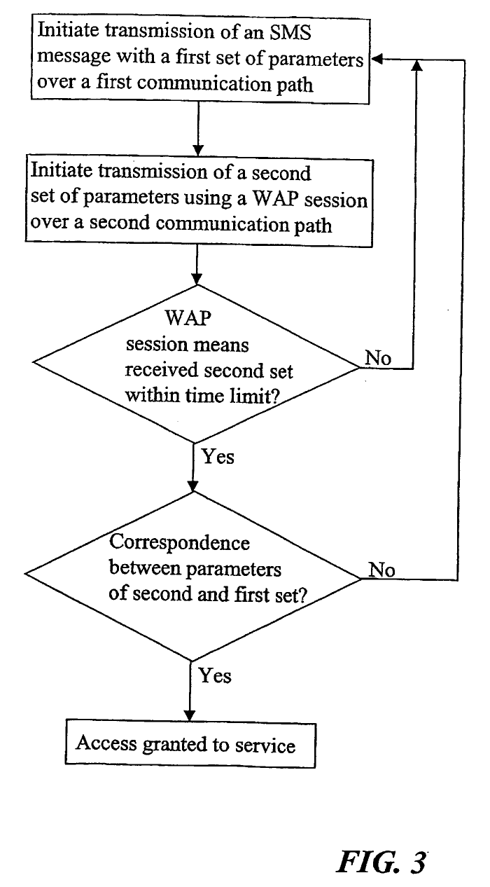

The following is an exemplifying description of the operation of the system shown in FIG. 2. This operation is also illustrated in the flow chart of FIG. 3.

When the user of the wireless terminal 100 wishes to access a service administrated by the server 120, he first initiated the transmission of an SMS message by making a request to the SMS-C 240. The implementation of this can be made in such way that the user simply presses a “w” for WAP session which automatically initiates a request of an SMS message to a pre-stored destination address designating the server 220. Upon reception of the SMS message by the SMS gateway 225 of server 220, the SMS gateway will match the MSISDN in the originating address filed of the SMS message against a table 228 storing user names and passwords corresponding to various MSISDN. The table may also include the time the user sent the SMS message. The database in which table 228 is stored may further include the network address relevant to the user, e.g., in this embodiment, the network address of e-mail account server 227. The SMS gateway then transfers the derived user name, and/or the received MSISDN, and the associated password as the first set of user identification parameters to the WAP session means 226. The SMS gateway also includes a time stamp which indicates the time of reception of the SMS message in the first set of parameters transferred to the WAP session means.

The user of the wireless terminal then accesses the server 220 within a certain time from effectuating the “w” command. The user performs this by simply selecting a URL (Uniform Resource Locator) bookmark designating the server 220. The URL is user specific and contains the username encrypted with a key only known by the server. The user has acquired this URL by first logging into a secure environment, like for example a corporate intranet, and then requesting that the URL be sent as an OTA (over the air) bookmark to the wireless terminal. This method prevents other users from trying to login to the account and guessing the password, while the SMS enabled window is open.

Having established a WAP session with the server 220, the user transmits a second set of parameters which includes his user name, and/or MSISDN, and the associated password. For example, the user name or MSISDN may be transmitted automatically by the application in the wireless terminal or by the user selecting a suitable command for the purpose. The user then completes the second set of parameters by entering his password, preferably in the form of the PIN code normally used when operating the wireless terminal.

The server 220 will upon reception of the second set of parameters compare the received user name and password of the second set with the user name and password forwarded by the SMS gateway. If there is a match, and if the second set of parameters were received within a predefined time limit following the time stamp included in the first set of parameters, the wireless terminal is authenticated by the server and access to the requested service is granted. In this case the user wishes to access his personal e-mail account, which means that the WAP session means 226 will communicate with the e-mail account server 227, using the network address relevant to the user and stored in association with the table 228 in the database as discussed above, to enable the user to access, by reading, deleting, transmitting etc., e-mails of/from his mailbox.

Preferably, the server 220 will format information of accessed e-mails such that the information can be transferred and suitably be displayed on the wireless terminal, e.g. shortening the messages and/or transferring the inbox subject headers together with sender and a number to enable retrieval of further information by selection of the number.

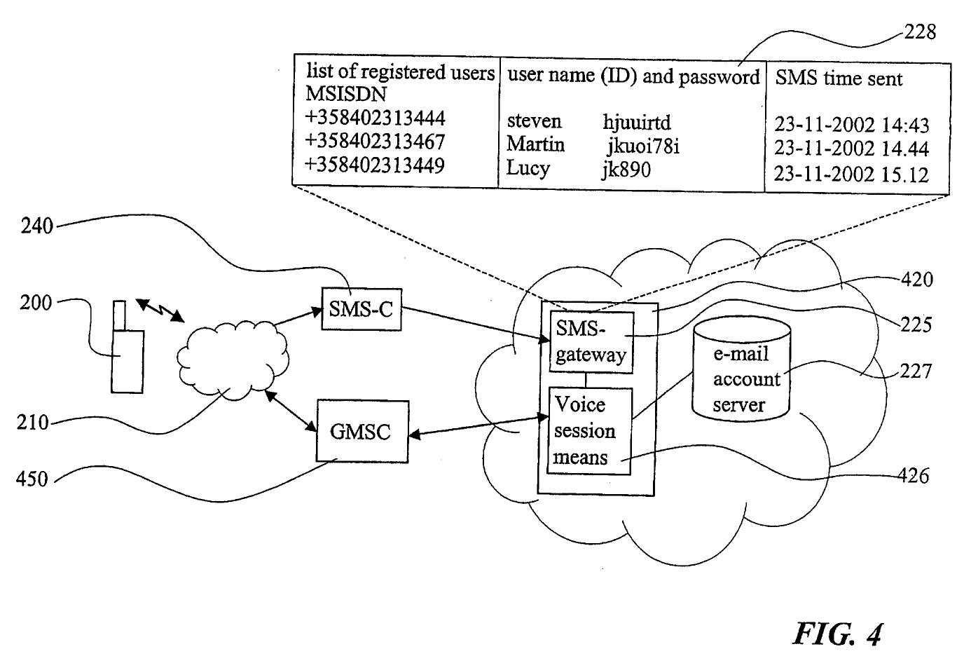

With reference to FIG. 4, yet another exemplifying embodiment of the invention will be described. This embodiment differs from the embodiment of FIG. 2 in that the second communication path is implemented via a GMSC (Gateway Mobile Switching Centre) 450 rather than via a WAP gateway. Also, the second server means of the server for communicating over the second communication path is implemented by voice session means 426 rather than WAP session means. In addition to the SMS gateway and the voice session means, the server 420 includes means for text-to-speech and speech-to-text conversion. The other elements in FIG. 4 correspond to those described in FIG. 2 and have therefore been given the same reference numerals as in FIG. 2.

The operation is similar to that of the embodiment in FIG. 2. The main difference is that the second set of parameters is transmitted by the user of the wireless terminal over a voice session established with the voice session means 426 of the server 420 over the GMSC 450. Preferably, the user of the terminal in this embodiment initiates the process by simply presses a “v” for Voice session, which command automatically initiates a request of an SMS message to a pre-stored destination address designating the server 420. The user then establishes a voice session with the server 420, e.g. by selecting a predefined destination address/number, and provides the server with the second set of parameters for authentication.

By means of the speech-to-text means the server is able to interpret command from the user when controlling the access to his mailbox account. Correspondingly, the text-to-speech means enables the server 420 to transform information from the mailbox account to speech to which the user may listen. This is obviously an advantageous way of accessing a mailbox account or any other service suitable for the same kind of access, since it, e.g., enables the user of the terminal to, in a safe way, access the service or mailbox while driving a car.

It is to be understood that the wireless terminal described in this document is either a stand-alone RF (Radio Frequency) transceiver having processing capabilities and displaying means, such as a mobile telephone or a hand-held PDA (Personal Digital Assistant), or, a RF transceiver arranged in communication with any kind of portable equipment having processing capabilities, such as a portable laptop computer.

It should be noted that the detailed description above of different embodiments of the invention has been given by way of illustration only and that these therefore are not intended to limit the scope of the invention, as it is defined by the appended claims.

1. A method for enabling a server on a packet switched network to authenticate a user of a wireless terminal prior to granting the terminal access to a service administrated by the server, the method including:
initiating, from the wireless terminal, transmission of a first set of user identification parameters to the server over a first communication path;
transmitting, from the wireless terminal, a second set of user identification parameters to the server over a second communication path;
obtaining access, at the wireless terminal over the second communication path, to the service in dependence on an authentication based on a match between the first set of user identification parameters and the second set of user identification parameters.

2. The method as claimed in claim 1, wherein said initiating step includes initiating transmission of an SMS (Short Message Service) message, which includes the first set of user identification parameters, from an SMS-C (Short Message Service Center) to the server.

3. The method as claimed in claim 1, wherein each set of said first set of user identification parameters and said second set of user identification parameters includes a user identification parameter and a password parameter.

4. The method as claimed in claim 3, wherein the user identification parameter is a user name or an MSISDN (Mobile Station Integrated Services Digital Network) number.

5. The method as claimed in claim 4, wherein the password parameter is a PIN (Personal Identity Number) code.

6. The method as claimed in claim 1, wherein said authentication is further based on the transmission of said second set of user identification parameters within a predefined time limit following the transmission of said first set of user identification parameters.

7. The method as claimed in claim 1, wherein said transmitting the second set of user identification parameters is effectuated by using a URL bookmark stored in the wireless terminal and designating the server.

8. The method as claimed in claim 7, wherein the URL is user specific and includes a username encrypted with a key only known to the server.

9. The method as claimed in claim 7, wherein the URL previously has been received from a corporate intranet as an OTA bookmark.

10. The method as claimed in claim 1, wherein said transmitting includes transmitting the second set of user identification parameters over a WAP (Wireless Application Protocol) session established between the wireless terminal and the server.

11. The method as claimed in claim 1, wherein the service administrated by the server concerns an electronic mailbox account associated with the user.

12. The method as claimed in claim 1, wherein said transmitting includes transmitting the second set of user identification parameters over a voice session established with the server, and wherein the server, by means of text-to-speech and speech-to-text conversion, provides the user with a service for listening to, and initiating transmission of, electronic mails via an electronic mailbox account associated with the user.

13. A system for enabling a server on a packet switched network to authenticate a user of a wireless terminal prior to granting the terminal access to a service administrated by the server, the system including:
first server means for receiving information over a first communication path;
second server means for receiving information over a second communication path;
the wireless terminal being adapted to initiate transmission of a first set of user identification parameters to the server over the first communication path and to transmit a second set of user identification parameters to the server over the second communication path; and
the server being adapted to base authentication of the wireless terminal on a match between the first set of user identification parameters and the second set of user identification parameters.

14. The system as claimed in claim 13, wherein said first server means is implemented by an SMS gateway and said first set of user identification parameters is included in a SMS message.

15. The system as claimed in claim 13, wherein each set of said first set of user identification parameters and said second set of user identification parameters includes a user identification parameter and a password parameter.

16. The system as claimed in claim 15, wherein the user identification parameter is a user name or an MSISDN number.

17. The system as claimed in claim 16, wherein the password parameter is a PIN code.

18. The system as claimed in claim 13, wherein authentication is further based on transmission of said second set of user identification parameters within a predefined time limit following transmission of said first set of user identification parameters.

19. The system as claimed in claim 13, wherein said second server means is implemented by WAP session means and said second set of user identification parameters is transmitted in a WAP session established between the wireless terminal and the server.

20. The system as claimed in claim 13, wherein the service administrated by the server concerns an electronic mailbox account associated with the user.

21. The system as claimed in claim 13, wherein said second server means is implemented by voice session means which includes means for text-to-speech and speech-to-text conversion for providing the user with a service for listening to, and initiating transmission of, electronic mails via an electronic mailbox account associated with the user.
